(19) United States
(12) Patent Application Publication
(10) Pub. No.: US 2020/0365503 A1
(43) Pub. Date: Nov. 19, 2020

(54) WIRING BOARD, ELECTRONIC DEVICE, AND METHOD FOR DESIGNING WIRING BOARD

(71) Applicant: FUJITSU LIMITED, Kawasaki-shi (JP)

(72) Inventor: KEIICHI YAMAMOTO, Yokohama (JP)

(73) Assignee: FUJITSU LIMITED, Kawasaki-shi (JP)

(21) Appl. No.: 16/872,433

(22) Filed: May 12, 2020

(30) Foreign Application Priority Data
May 15, 2019 (JP) 2019-092465

(51) Int. Cl. H01L 23/498; H01L 23/31; G06F 30/392

(52) U.S. Cl. CPC H01L 23/49838; H01L 23/49811; G06F 2115/12; G06F 30/392; H01L 23/3157

(57) ABSTRACT

A wiring board includes a plurality of first pads provided in a mounting area on which an electronic component that has a plurality of electrodes is mounted and coupled to the plurality of electrodes; and a plurality of second pads provided in the mounting area and not coupled to the plurality of electrodes, wherein a length of a gap between adjacent pads, among the first pads and the second pads, is 0.18 mm or more and 0.56 mm or less.

### CROSS-REFERENCE TO RELATED APPLICATION

This application is based upon and claims the benefit of priority of the prior Japanese Patent Application No. 2019-92465, filed on May 15, 2019, the entire contents of which are incorporated herein by reference.

### FIELD

The disclosed technology is related to a wiring board, an electronic device, and a method for designing the wiring board.

### BACKGROUND

The following technology is known as technology related to an electronic device including a dummy pad. For example, an electronic device including a semiconductor device and a printed wiring board is known. In the electronic device, the semiconductor device includes a part provided with a plurality of solder ball bumps and a part provided with no solder ball bump, and the printed wiring board includes a plurality of electrode pads joined to the solder ball bumps provided on the semiconductor device. This electronic device includes a resin material filled around the solder ball bumps of the semiconductor device and around the electrode pads of the printed wiring board. The printed wiring board has a plurality of dummy electrode pads provided facing a part, of the semiconductor device, provided with no solder ball bump.

Furthermore, an electronic device including a Ball Grid Array (BGA), which has a plurality of BGA electrodes on one surface, and a circuit board is known. In the electronic device, the circuit board is provided with a plurality of first substrate electrode pads corresponding to the BGA electrodes and with a plurality of second substrate electrode pads corresponding to parts having no BGA electrode. This electronic device includes protrusions and an adhesive. With thickness predetermined by solder, the protrusions are formed on the plurality of second substrate electrode pads between the BGA and the circuit board, in a state where the BGA electrodes and substrate electrode pads are joined by solder. The adhesive includes resin and is provided between the BGA and the circuit board.

Japanese Laid-open Patent Publication No. 2010-27722 and Japanese Laid-open Patent Publication No. 2009-238788 are disclosed as related art.

In recent years, application, to products, of an electronic component such as Land Grid Array (LGA) or Quad Flatpack No Lead (QFN), which has electrodes on a bottom face, has been accelerated. LGA and QFN are different from Ball Grid Array (BGA) in that electrodes formed on the bottom face have no solder ball. In a case where an electronic component such as LGA or QFN is implemented on a wiring board, electrodes formed on the bottom face of the electronic component and pads formed on the wiring board are joined by solder.

However, with LGA and QFN, there have been cases where reliability of solder joint with a wiring board fails to satisfy a required level. Furthermore, with a trend toward finer pitch of electronic components, a minimum gap between conductors after solder joint has been not able to satisfy a standard. To deal with the above issues, underfilling is used. In the underfilling, a gap between the electronic component and the wiring board is filled with thermohardening resin (hereinafter, referred to as underfill material) including a filler. With the underfilling, reliability of solder joint may be improved, because periphery of a solder joint part is covered by a hardened underfill material. Furthermore, insulation between the electrodes may be ensured, because a wall of an insulation material may be formed in a gap between the solder joint parts.

However, a dimension, in a height direction, of gaps formed between fine-pitch type LGA or fine-pitch type QFN and the wiring board are about 20 μm to 40 μm, which is very narrow. Furthermore, in a case where distances between the plurality of electrodes formed on a bottom face of the LGA or the QFN are not uniform, a dimension, in a planar direction, of gaps formed between the LGA or the QFN and the wiring board are not uniform. In this case, if the underfilling is applied, flow speed of an underfill material flowing toward gaps having a relatively large dimension in the planar direction decreases, and the gaps are insufficiently filled with the underfill material. An unfilled portion of the underfill material is referred to as a void, and generation of the void may reduce reliability of a solder joint.

To reduce void occurrence, an underfill material including no filler and having high fluidity may be used. However, in this case, reliability of the solder joint may be reduced. Alternatively, an underfill material containing a filler having a particle diameter smaller than usual may be used. However, such an underfill material may be expensive and may cause an increase in a manufacturing cost. In view of the above, it is desirable to be able to enhance filling property of the underfill material filled in gaps between the electronic component and the wiring board.

### SUMMARY

According to an aspect of the embodiments, a wiring board includes a plurality of first pads provided in a mounting area on which an electronic component that has a plurality of electrodes is mounted and coupled to the plurality of electrodes; and a plurality of second pads provided in the mounting area and not coupled to the plurality of electrodes, wherein a length of a gap between adjacent pads, among the first pads and the second pads, is 0.18 mm or more and 0.56 mm or less.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example perspective view of a configuration of an electronic device according to an embodiment of the disclosed technology;

FIG. 2 is a plan view of an electronic component according to the embodiment of the disclosed technology, as viewed from a side of a joint surface to a wiring board;

FIG. 3 is a plan view of a wiring board according to the embodiment of the disclosed technology, as viewed from a side of a joint surface to the electronic component;

FIG. 4 is a cross-sectional view taken along line 4-4 in FIG. 1;

FIG. 5 is an example plan view of arrangement of regular pads and dummy pads according to the embodiment of the disclosed technology;

FIG. 6 is an example flowchart of a procedure for layout design of the regular pads and dummy pads of the wiring board according to the embodiment of the disclosed technology;

FIG. 7A is a plan view of the wiring board corresponding to each step of the flowchart illustrated in FIG. 6;

FIG. 7B is a plan view of the wiring board corresponding to each step of the flowchart illustrated in FIG. 6;

FIG. 7C is a plan view of the wiring board corresponding to each step of the flowchart illustrated in FIG. 6;

FIG. 7D is a plan view of the wiring board corresponding to each step of the flowchart illustrated in FIG. 6;

FIG. 7E is a plan view of the wiring board corresponding to each step of the flowchart illustrated in FIG. 6;

FIG. 8A is an example cross-sectional view of a method for manufacturing the electronic device according to the embodiment of the disclosed technology;

FIG. 8B is an example cross-sectional view of the method for manufacturing the electronic device according to the embodiment of the disclosed technology;

FIG. 8C is an example cross-sectional view of the method for manufacturing the electronic device according to the embodiment of the disclosed technology;

FIG. 9 is a schematic diagram of a flow of an underfill material in a case where the wiring board according to the embodiment of the disclosed technology is used;

FIG. 10 is a schematic diagram of a flow of the underfill material in a case where a wiring board according to Comparative Example is used;

FIG. 11A is a partial plan view of a wiring board according to another embodiment of the disclosed technology;

FIG. 111 is an example partial plan view of a form of dummy pads according to the other embodiment of the disclosed technology; and

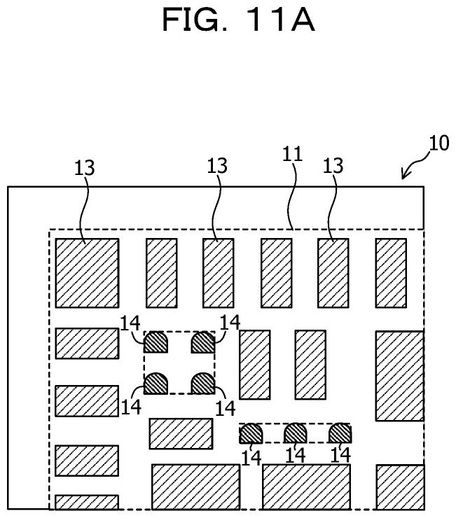

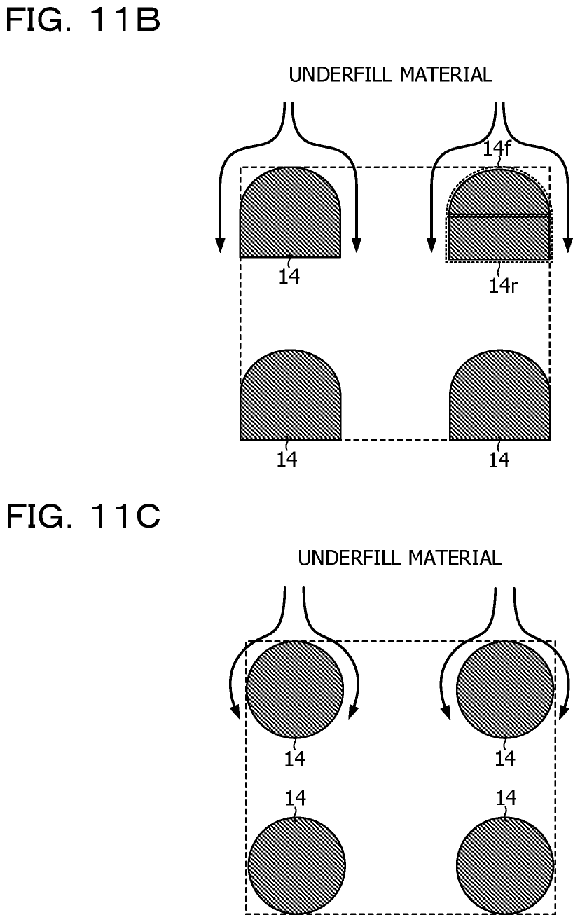

FIG. 11C is an example partial plan view of a form of dummy pads according to the other embodiment of the disclosed technology.

### DESCRIPTION OF EMBODIMENTS

An example of an embodiment of the disclosed technology will be described in detail below with reference to the drawings. In each of the drawings, the same or equivalent components and parts are denoted by the same reference numerals.

### First Embodiment

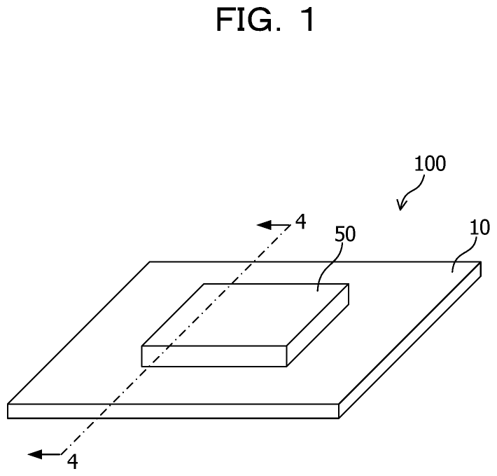

FIG. 1 is an example perspective view of a configuration of an electronic device 100 according to an embodiment of the disclosed technology. The electronic device 100 includes a wiring board 10 and an electronic component 50 mounted on the wiring board 10.

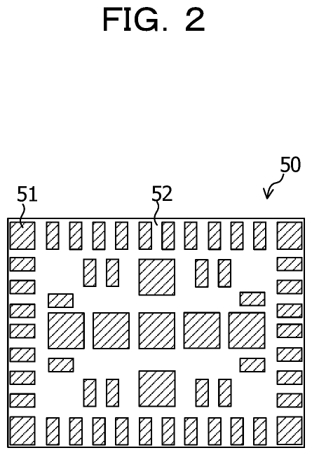

FIG. 2 is a plan view of the electronic component 50, as viewed from a side of a joint surface to the wiring board 10. In this embodiment, the electronic component 50 is a semiconductor device having a form of LGA, and has a plurality of electrodes 51 on a joint surface to the wiring board 10. A surface of the electrodes 51 is exposed from a surface of mold resin 52 and extends in the same plane as the surface of the mold resin 52. Each of the electrodes 51 is rectangular, and vertical and horizontal dimension of the electrodes 51 and distances between the electrodes 51 are not uniform. In other words, the electronic component 50 has an electrode configuration different from an electrode configuration of a general BGA in which a plurality of solder balls is disposed at equal intervals on the joint surface to the wiring board 10. The electronic component 50 includes one or more semiconductor chips (not illustrated) embedded inside the mold resin 52, and each of the electrodes 51 is electrically connected to a terminal of the semiconductor chips. Note that the electronic component 50 may have a form of QFN. An electronic component 50 having the form of QFN has an electrode not only on the joint surface to a wiring board 10. The electronic component 50 also has an electrode, which is exposed from a surface of the mold resin 52, on a side surface.

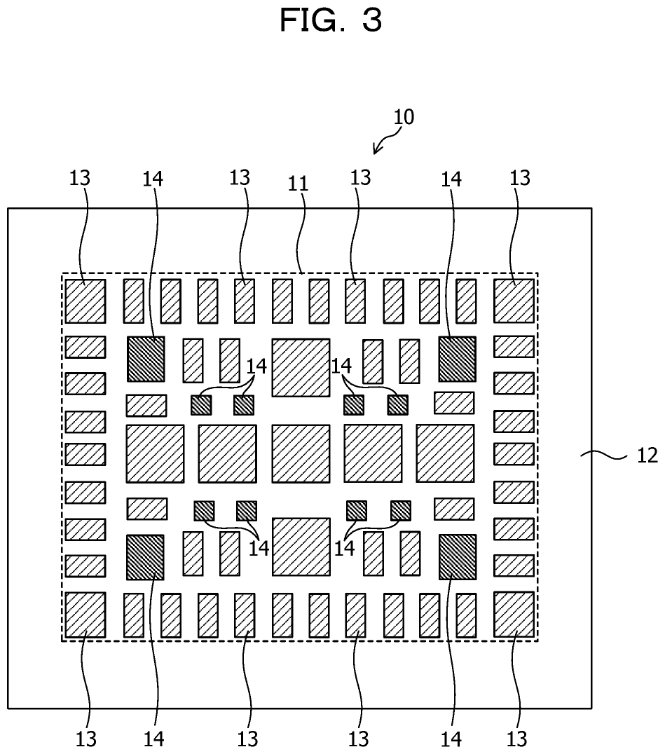

FIG. 3 is a plan view of the wiring board 10, as viewed from a side of a joint surface to the electronic component 50. The area surrounded by the dotted line in FIG. 3 is a mounting area 11 on which the electronic component 50 is mounted. The wiring board 10 includes a base material 12 having an insulating property, and a plurality of regular pads 13 and a plurality of dummy pads 14, which are provided on a surface of the base material 12. The base material 12 includes, for example, an insulator such as glass epoxy resin. The regular pads 13 and the dummy pads 14 include, for example, a conductor such as copper.

Each of the regular pads 13 is provided in the mounting area 11, and is electrically and mechanically connected to each of the plurality of electrodes 51 of the electronic component 50. Each of the regular pads 13 corresponds to each of the electrodes 51 of the electronic component 50, and has a shape, size, and arrangement equivalent to a shape, size, and arrangement of a corresponding electrode 51. Each of the dummy pads 14 is provided in the mounting area 11, and is not electrically and mechanically connected to each of the electrodes 51 of the electronic component 50. In this embodiment, the dummy pads 14 are rectangular and have ununiformed vertical and horizontal dimensions.

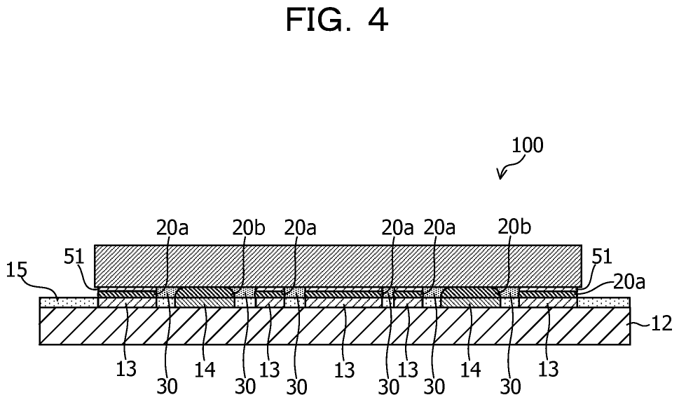

FIG. 4 is a cross-sectional view taken along line 4-4 in FIG. 1. Each of the regular pads 13 is joined to a corresponding electrode 51 by solder 20a. With this arrangement, the wiring board 10 and the electronic component 50 are electrically and mechanically connected. Solder 20b is provided on a surface of each of the dummy pads 14. Although it is preferable that an upper surface of the solder 20b be in contact with a lower surface of the electronic component 50 as illustrated in FIG. 4, the upper surface of the solder 20b may not be in contact with the lower surface of the electronic component 50.

A solder resist 15 is provided on the surface of the base material 12, and the regular pads 13 and the dummy pads 14 are exposed from openings of the solder resist 15. Surrounding peripheries of the regular pads 13 and the dummy pads 14 with the solder resist 15 may reduce a risk of the solder on the regular pads 13 and the dummy pads 14 fusing, that causes a short circuit between electrodes.

The electronic device 100 has an underfill material 30 provided between the electronic component 50 and the wiring board 10. As the underfill material 30, for example, a material obtained by containing a filler into thermohardening resin such as epoxy resin can be used. As the filler, for example, powder of an inorganic material such as silica or alumina can be used. Reliability of the solder joint is improved by periphery of the solder 20a, which joins the electrodes 51 and the regular pads 13, being covered with the underfill material 30 that has been hardened.

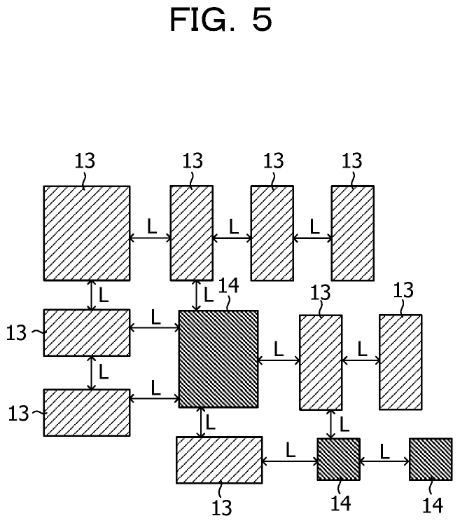

In the wiring board 10, a length L of a gap between adjacent pads, among the regular pads 13 and the dummy pads 14, as illustrated in FIG. 5, is set to be 0.18 mm or more and 0.56 mm or less. The length 0.18 mm is a length required for stable arrangement of a solder resist in manufacturing a substrate. The length 0.56 mm is derived from a minimum length required in manufacturing a substrate when a dummy pad is placed such that the solder resist at both sides of the dummy pad is 0.18-mm wide, given that a length of each side of the dummy pad is required to be 0.2 mm or more for stable arrangement of the dummy pad. When the length L between the adjacent pads is in the above-described range, permeability (fluidity) of an underfill material may be ensured. The length of each side of the dummy pads 14 is set to be 0.2 mm or more and 2.0 mm or less. The maximum value 2.0 mm is derived from printing (supply) stability of solder paste. In a case where a dummy pad having a side length of more than 2.0 mm can be placed, the dummy pad is placed after being divided.

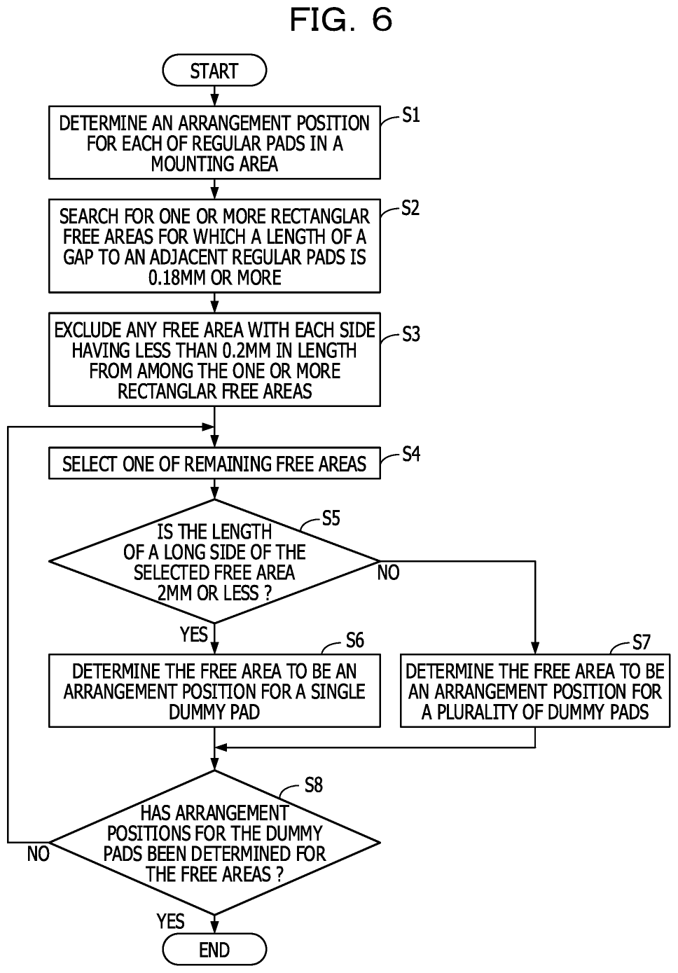

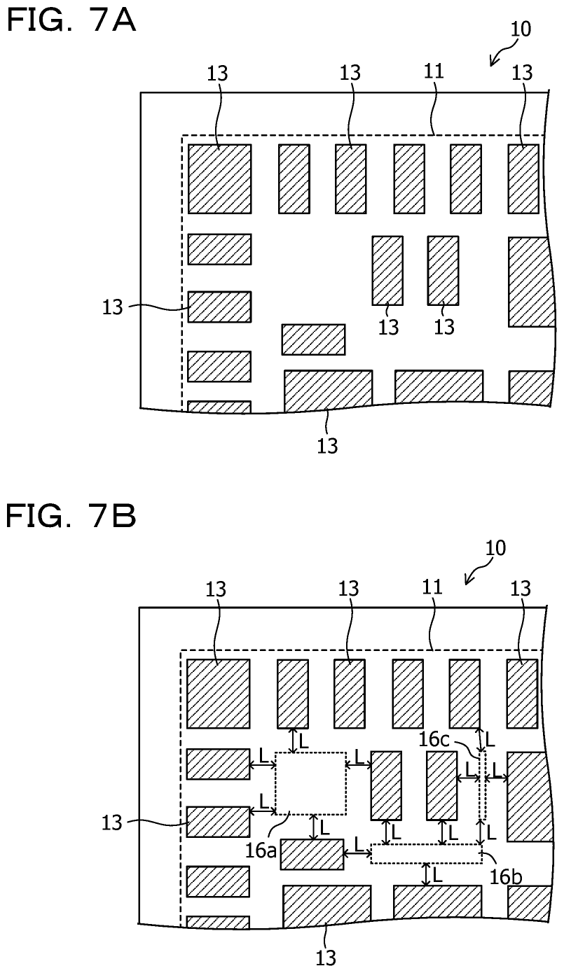

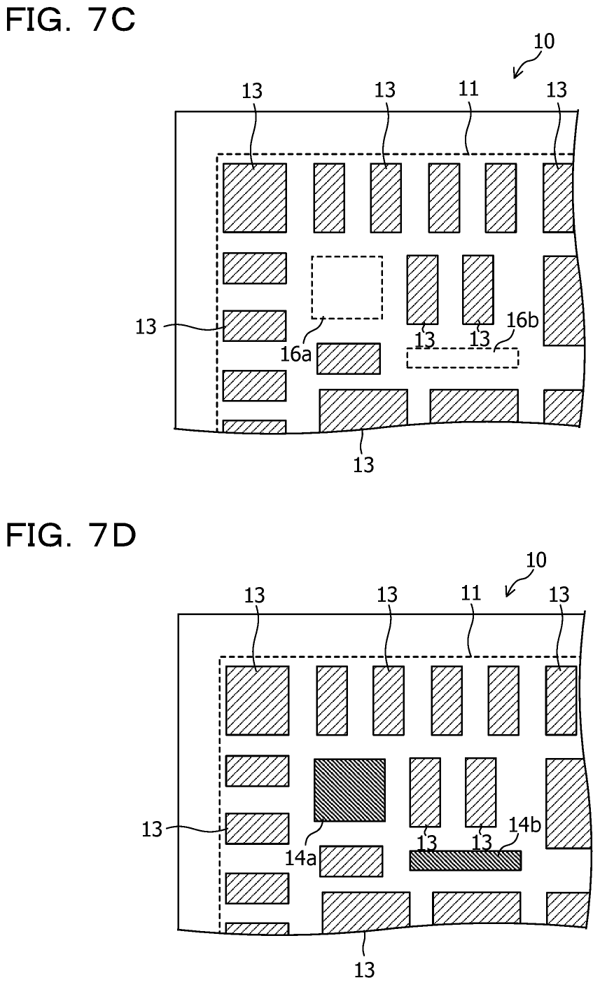

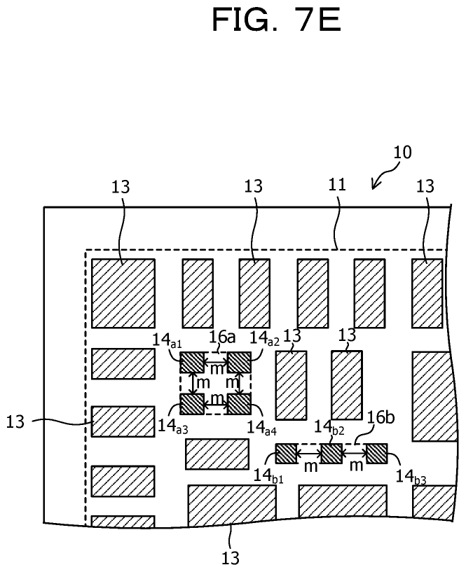

FIG. 6 is an example flowchart of a procedure for layout design of the regular pads 13 and dummy pads 14 of the wiring board 10. FIGS. 7A to 7E are plan views of the wiring board 10 corresponding to each step of the flowchart illustrated in FIG. 6.

In step S1, an arrangement position for each of the regular pads 13 is determined in the mounting area 11 for the electronic component 50 on the wiring board 10 (FIG. 7A). Each of the arrangement positions for the regular pads 13 are determined so as to correspond to each of arrangement positions for the electrodes 51 of the electronic component 50.

In step S2, a search is made in the mounting area 11 for a rectangular free area for which a length L of a gap to an adjacent regular pad 13 is 0.18 mm or more (FIG. 7B). FIG. 7B illustrates free areas 16a, 16b, 16c that satisfy the conditions described above.

In step S3, from among free areas found in step S2, any free area with each side having less than 0.2 mm in length is excluded (FIG. 7C). FIG. 7C illustrates a case where the free area 16c is excluded.

In step S4, one of the remaining free areas is selected, and in step S5, it is determined whether or not a length of a long side of the selected free area is 2 mm or less.

In a case where the length of the long side of the selected free area is 2 mm or less, the free area is determined to be an arrangement position for a single dummy pad 14 in step S6 (FIG. 7D). FIG. 7D illustrates a case where a length of a long side of each of the free areas 16a, 16b is 2 mm or less, the free area 16a is determined to be an arrangement position for a single dummy pad 14a, and the free area 16b is determined to be an arrangement position for a single dummy pad 14b.

Meanwhile, in a case where the length of the long side of the selected free area is more than 2 mm, the free area is determined to be an arrangement position for a plurality of dummy pads 14 in step S7. In other words, the plurality of dummy pads 14 is divided and arranged in the free area. FIG. 7E illustrates a case where arrangement positions for a plurality of dummy pads 14ₐ₁, 14ₐ₂, 14ₐ₃, 14ₐ₄ are determined in the free area 16a. FIG. 7E illustrates a case where arrangement positions for a plurality of dummy pads 14_{b1}, 14_{b2}, 14_{b3} are determined in the free area 16b.

For the plurality of dummy pads 14 divided and arranged in a single free area, a length of each side is preferably 0.2 mm or more and 0.5 mm or less. In addition, a length m of a gap between adjacent dummy pads 14, as illustrated in FIG. 7E, is preferably 0.18 mm or more and 0.56 mm or less, and is preferably uniform. It is preferable that the dummy pads 14 be arranged at each corner of a free area or at both ends of the free area.

In step S8, it is determined whether or not arrangement positions for the dummy pads 14 have been determined for all the free areas. In a case where there is any free area in which an arrangement position for a dummy pad 14 is not determined, the processing returns to step S4, a new free area is selected, and the processing from steps S5 to S7 is performed for the new free area. When arrangement positions for the dummy pads 14 are determined for all the free areas, the layout design of the regular pads 13 and dummy pads 14 is completed.

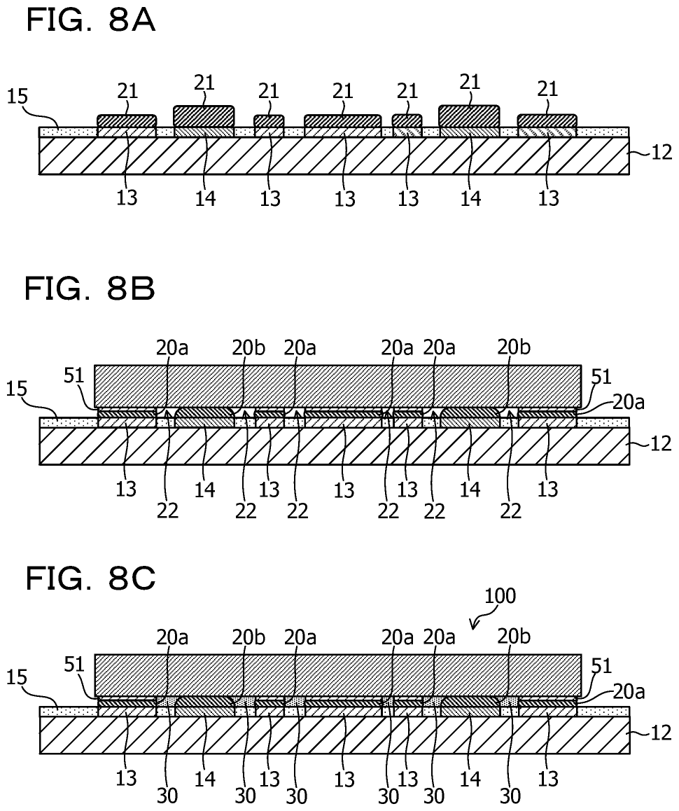

A method for manufacturing the electronic device 100 will be described below. FIGS. 8A to 8C are example cross-sectional views of a method for manufacturing the electronic device 100.

First, solder paste 21 is printed on a surface of each of the regular pads 13 and the dummy pads 14 of the wiring board 10 (FIG. 8A). It is preferable that an amount of the solder paste 21 supplied to a surface of a dummy pad 14 be adjusted so that the solder paste 21 after being melt is higher than a gap formed between the electronic component 50 and the wiring board 10. With this arrangement, the upper surface of the solder 20b arranged on the dummy pads 14, as illustrated in FIG. 4, comes into contact with the lower surface of the electronic component 50. As illustrated in FIG. 8A, the solder paste 21 supplied to a surface of a dummy pad 14 may be higher than the solder paste 21 formed on a surface of a regular pad 13.

Next, the electronic component 50 is mounted on the mounting area 11 of the wiring board 10. Next, the solder paste 21 is melted by reflow, and then, the electronic component 50 and the wiring board 10 are exposed to a room temperature environment to solidify the solder paste 21. With this arrangement, each of the regular pads 13 and each of the corresponding electrodes 51 of the electronic component 50 are joined by the solder 20a. Furthermore, the solder 20b is formed on the dummy pads 14 by the solder paste 21 on the dummy pads 14 being melted and solidified. It is preferable that the upper surface of the solder 20b be in contact with the lower surface of the electronic component 50. A gap 22 corresponding to thickness of the solders 20a and 20b is formed between the wiring board 10 and the electronic component 50 (FIG. 88).

Next, the gap 22 formed between the wiring board 10 and the electronic component 50 is filled with the underfill material 30. The underfill material 30 is injected, for example, from one side or adjacent two sides of the electronic component 50 (mounting area 11). The underfill material 30 before being hardened is in a liquid state and flows toward an opposite side to a side where the underfill material 30 is supplied, along flow paths defined by the solder 20a formed on the regular pads 13 and the solder 20b formed on the dummy pads 14. Then, the underfill material 30 is hardened by heat treatment (FIG. 8C).

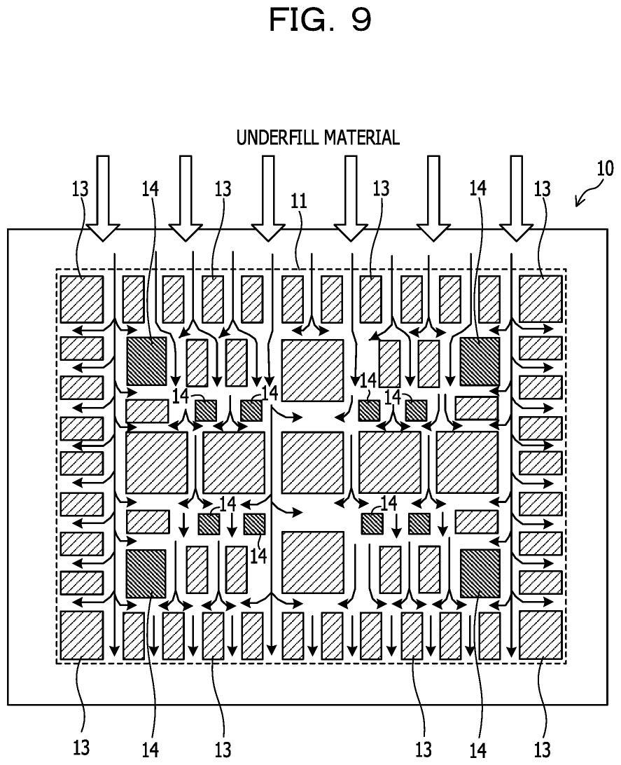

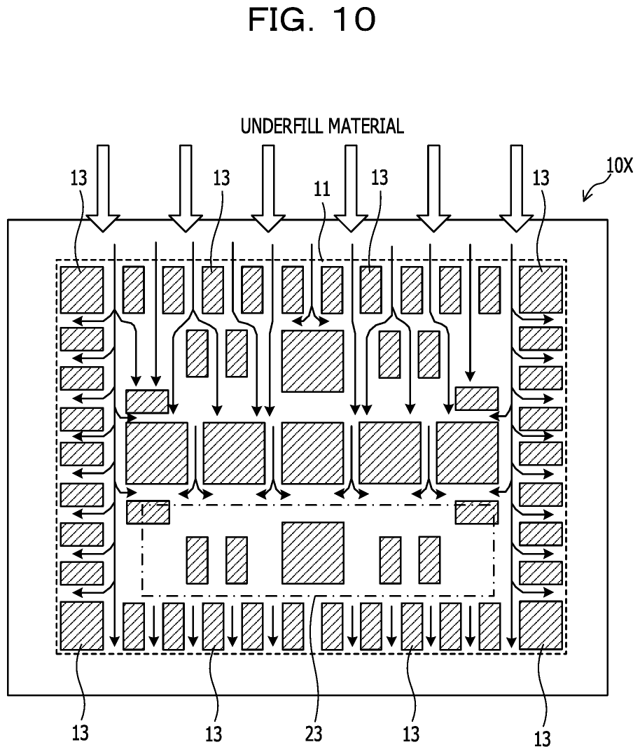

FIG. 9 is a schematic diagram of a flow of the underfill material 30 in a case where the wiring board 10 according to the embodiment of the disclosed technology is used. FIG. 10 is a diagram of a flow of the underfill material 30 in a case where a wiring board 10X according to Comparative Example without a dummy pad is used. FIGS. 9 and 10 illustrate an example of a case where the underfill material 30 is supplied from one upper side in the drawings.

Because the wiring board 10X according to Comparative Example does not have a dummy pad, a vacant space having a relatively large area is formed in the mounting area 11. The vacant space is a free area where no pad is formed, and is like an area 23 surrounded by the alternate long and short dash line in FIG. 10. In other words, an area having a relatively wide flow path through which the underfill material 30 flows is formed. Therefore, in the area 23, flow speed of the underfill material 30 may decrease, resulting in insufficient supply of the underfill material 30. For example, in the area 23, a void, which is an unfilled portion of the underfill material 30, may be generated.

Meanwhile, by the wiring board 10 according to the embodiment of the disclosed technology, dummy pads 14 are provided in a free area where no regular pad 13 is formed. With this arrangement, it may be possible to reduce generation of a vacant space, which is a free area where no pad is formed, having a relatively large area in the mounting area 11. For example, an area having a relatively wide flow path through which the underfill material 30 flows is less possible to be formed. Therefore, it may be possible to suppress a decrease in the flow speed of the underfill material 30 and to supply the underfill material 30 over an entire area of the gap 22 formed between the electronic component 50 and the wiring board 10. In other words, by the wiring board 10 according to the embodiment of the disclosed technology, filling property of the underfill material 30 may be enhanced without using an underfill material containing no filler or an underfill material including a filler with a particle diameter smaller than usual. Therefore, generation of a void, which is an unfilled portion of the underfill material 30, may be reduced, and reliability of solder joint between the electronic component 50 and the wiring board 10 may be improved.

Furthermore, by the wiring board 10, a length L of a gap between adjacent pads as illustrated in FIG. 5 is set to 0.56 mm or less, and therefore, an effect of maintaining the flow speed of the underfill material 30 may be enhanced. Moreover, by the wiring board 10, the length L of the gap between adjacent pads as illustrated in FIG. 5 is set to 0.18 mm or more, and therefore, the flow paths through which the underfill material 30 flows are less likely to be excessively narrow, ensuring permeability of the underfill material 30. Furthermore, the solder resist 15 may be appropriately placed between the regular pad 13 and the dummy pad 14.

By the wiring board 10, a length of each side of a dummy pad 14 is set to 0.2 mm or more and 2.0 mm or less, and therefore, solder paste may be appropriately printed on the dummy pad 14.

By a method for designing the wiring board 10 according to the embodiment of the disclosed technology, in a case where a length of a long side of a free area where a regular pad 13 is not formed is 2 mm or less, the free area is determined to be an arrangement position for a single dummy pad 14. Meanwhile, in a case where the length of the long side of the free area where a regular pad 13 is not formed is more than 2 mm, the free area is determined to be an arrangement position for a plurality of dummy pads 14. With this arrangement, a size of a dummy pad 14 may be set to a size that allows the solder paste to be appropriately printed. Furthermore, for each of the plurality of dummy pads 14 arranged in a single free area, a length of a gap m to an adjacent dummy pad 14 is set to 0.18 mm or more and 0.56 mm or less. With this arrangement, the effect of maintaining the flow speed of the underfill material 30 may be enhanced while ensuring the permeability of the underfill material 30.

### Second Embodiment

FIG. 11A is a partial plan view of a wiring board 10 according to a second embodiment of the disclosed technology. FIG. 11B is an example partial plan view of a form of dummy pads 14 according to the second embodiment of the disclosed technology. In the wiring board 10 according to the first embodiment described above, the dummy pads 14 were rectangular. Meanwhile, in the wiring board 10 according to this embodiment, an outer edge of a front part 14f of a dummy pad 14, which first comes into contact with an underfill material 30 injected from an end of a mounting area 11, is curved so as to protrude toward an end, of a side of the mounting area 11, from where the underfill material 30 is injected. Thus, with a streamline-shaped front part 14f of the dummy pad 14, as illustrated in FIG. 11B, a flow, to backward of the dummy pads 14, of the underfill material 30 in contact with the dummy pads 14 may be promoted.

Furthermore, an outer edge of a rear part 14r of the dummy pads 14 according to the second embodiment has a linear shape along a flow direction of the underfill material 30. The outer edge of the rear part 14r is continuous with the outer edge of the front part 14f. The flow direction of the underfill material 30 is a direction, in the mounting area 11, from the end of the side from where the underfill material 30 is injected, toward an opposite end. Thus, with the outer edge of the rear part 14r of the dummy pad 14, the outer edge having a linear shape along the flow direction of the underfill material 30, straightness of the underfill material 30 may be enhanced, and the effect of maintaining the flow speed of the underfill material 30 may be enhanced.

Meanwhile, in a case where the dummy pad 14 is circular as illustrated in FIG. 11C, the underfill material 30 flows along a circular outer edge of the dummy pad 14 and wraps around the dummy pad 14. Therefore, the straightness of the underfill material 30 is reduced, and the flow speed of the underfill material 30 decreases. Therefore, it is preferable that the dummy pads 14 have a form as illustrated in FIG. 118.

The wiring board 10 is an example of a wiring board in the disclosed technology. The mounting area 11 is an example of a mounting area in the disclosed technology. The regular pad 13 is an example of a first pad in the disclosed technology. The dummy pad 14 is an example of a dummy pad in the disclosed technology. The front part 14f is an example of a first part in the disclosed technology. The rear part 14r is an example of a second part in the disclosed technology. The underfill material 30 is an example of resin including a filler in the disclosed technology. An electronic component 50 is an example of an electronic component in the disclosed technology. An electrode 51 is an example of an electrode in the disclosed technology. An electronic device 100 is an example of an electronic device in the disclosed technology.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wiring board comprising:
a plurality of first pads provided in a mounting area on which an electronic component that has a plurality of electrodes is mounted and coupled to the plurality of electrodes; and
a plurality of second pads provided in the mounting area and not coupled to the plurality of electrodes,
wherein a length of a gap between adjacent pads, among the first pads and the second pads, is 0.18 mm or more and 0.56 mm or less.

2. The wiring board according to claim 1,
wherein a length of each side of the second pads is 0.2 mm or more and 2.0 mm or less.

3. The wiring board according to claim 1,
wherein an outer edge of a first part of the second pads is curved so as to protrude toward an end of the mounting area, the outer edge of the first part of the second pads being in contact with resin injected from the end of the mounting area.

4. The wiring board according to claim 3,
wherein an outer edge of a second part of the second pads has a linear shape along a flow direction of the resin, the outer edge of the second part of the second pads being continuous with the outer edge of the first part.

5. An electronic device comprising:
an electronic component that has a plurality of electrodes on a surface;
a wiring board that has a mounting area on which the electronic component is mounted; and
a resin provided between the electronic component and the wiring board,
wherein the wiring board includes:
a plurality of first pads provided in the mounting area and coupled to the plurality of electrodes, and
a plurality of second pads provided in the mounting area and not coupled to the plurality of electrodes,
wherein a length of a gap between adjacent pads, among the first pads and the second pads, is 0.18 mm or more and 0.56 mm or less,
each of the plurality of electrodes and each of the plurality of first pads are joined by solder, and
the solder is provided on a surface of each of the plurality of second pads.

6. The electronic device according to claim 5,
wherein a length of each side of the second pads is 0.2 mm or more and 2.0 mm or less.

7. The electronic device according to claim 5,
wherein an outer edge of a first part of the second pads is curved so as to protrude toward an end of the mounting area, the outer edge of the first part of the second pads being in contact with resin injected from the end of the mounting area.

8. The electronic device according to claim 7,
wherein an outer edge of a second part of the second pads has a linear shape along a flow direction of the resin, the outer edge of the second part of the second pads being continuous with the outer edge of the first part.

9. A method for designing a wiring board, the method comprising:
determining arrangement positions, in a mounting area on which an electronic component is mounted, for a plurality of first pads coupled to electrodes of the electronic component;
searching, in the mounting area, for a free area in a rectangular shape, the free area having a length of a gap of 0.18 mm or more to adjacent first pads, and having a length of 0.2 mm or more at each side; and
determining an arrangement position, in the free area, for a second pad not coupled to the electrodes of the electronic component.

10. The method according to claim 9, wherein
when the length of each side of the free area is equal to or less than a predetermined value, the free area is determined to be an arrangement position for a single second pad.

11. The method according to claim 9, wherein
when a length of a long side of the free area is more than a predetermined value, the free area is determined to be an arrangement position for a plurality of second pads.
